(19) United States
(12) Patent Application Publication
(10) Pub. No.: US 2014/0041035 A1
(43) Pub. Date: Feb. 6, 2014

(54) METHOD AND SYSTEM FOR FILE SCANNING

(71) Applicant: Tencent Technology (Shenzhen) Company Limited, Shenzhen City (CN)

(72) Inventor: Zi-Xiao Nie, Shenzhen City (CN)

(73) Assignee: Tencent Technology (Shenzhen) Company Limited, Shenzhen City (CN)

(21) Appl. No.: 14/021,880

(22) Filed: Sep. 9, 2013

Related U.S. Application Data
(63) Continuation of application No. PCT/CN2013/079889, filed on Jul. 23, 2013.

(30) Foreign Application Priority Data
Jul. 25, 2012 (CN) 201210259530.9

(51) Int. Cl. G06F 21/56

(52) U.S. Cl. CPC G06F 21/568
USPC 726/24

(57) ABSTRACT

The invention relates to method and system for file scanning The method includes performing specified scanning on files of terminal equipment to determine suspicious files infected by viruses; repairing the suspicious files infected by the viruses and recording repair actions; and checking the recorded repair actions after the specified scanning is finished. The system includes a scanning module, a repairing module, and a checking module. According to the invention, repair actions performed during the repair procedure are recorded when suspicious files infected by viruses are repaired, and these recorded repair actions are checked after the repairs are finished so as to confirm the repair effect and reinforce the repair, thereby preventing suspicious files infected by various viruses from damaging and infecting the system.

### CROSS-REFERENCE TO RELATED APPLICATIONS

This application is a continuation application of International Patent Application No. PCT/CN2013/079889, filed Jul. 23, 2013, which itself claims the priority to Chinese Patent Application No. 201210259530.9, filed Jul. 25, 2012 in the State Intellectual Property Office of P.R. China, which are hereby incorporated herein in their entireties by reference.

### FIELD OF THE INVENTION

The present invention relates generally to computer security, and more particularly to method and system for file scanning

### BACKGROUND OF THE INVENTION

Computer virus has a clear definition in “Regulations of the People's Republic of China for Security Protection of Computer Information Systems”, which refers to a set of computer instructions or program codes that are inserted during compiling or inserted in a computer program and capable of damaging computer functions or data, affecting the use of a computer, and replicating themselves.

To deal with damages and impacts on a system by a running suspicious file, conventionally technical solutions usually use antivirus software to scan hard drives, and after the scanning is finished, suspicious files detected during the scanning are repaired. Repaired objects are merely viruses or suspicious files that affect the system.

With variations and advancement of the virus technology, a suspicious file infected by the virus usually hides itself by residing in a system process. When the system process is running, it is not easy for antivirus software to end the running of the suspicious file infected by the virus. Therefore, the suspicious file infected by the virus can successfully reside in a medium such as a process or a registration table, which gives the suspicious file another chance of running.

The conventionally technical solutions have at least the following shortcomings. It only scans and repairs suspicious files infected by viruses, which no longer meets antivirus requirements. Especially, in the case when a stubborn suspicious file infected by the virus cannot be repaired thoroughly, the system is still at risk. Further, even after another round of scanning, the suspicious file infected by the virus cannot still be repaired successfully, resulting in low antivirus efficiency.

Therefore, a heretofore unaddressed need exists in the art to address the aforementioned deficiencies and inadequacies.

### SUMMARY OF THE INVENTION

One of the objectives of the present invention is to provide method and system for file scanning.

In one aspect of the present invention, the method for file scanning includes performing specified scanning on files of terminal equipment to determine suspicious files infected by viruses; repairing the suspicious files infected by the viruses and recording repair actions; and checking the recorded repair actions after the specified scanning is finished.

In another aspect of the invention, the system for file scanning includes a scanning module configured to perform specified scanning on files of terminal equipment to determine suspicious files infected by viruses; a repairing module configured to repair the suspicious files infected by the viruses and recording repair actions; and a checking module configured to check the recorded repair actions after the specified scanning is finished.

In a further aspect, the present invention relates to a non-transitory computer-readable medium storing instructions which, when executed by one or more processors, cause the system to perform the above method for file scanning.

The embodiments of the present invention provide method and system for file scanning, in which repair actions performed during the repair procedure are recorded when suspicious files infected by viruses are repaired, and these recorded repair actions are checked after the repairs are finished so as to confirm the repair effect and reinforce the repairs, thereby preventing suspicious files infected by various viruses from damaging and affecting the system.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention.

FIG. 1 is a flow chart of a method for file scanning according to one embodiment of the present invention.

FIG. 2 is a flow chart of a method for file scanning according to another embodiment of the present invention.

FIG. 3 is a schematic structural diagram of a system for file scanning according to one embodiment of the present invention.

### DETAILED DESCRIPTION OF THE INVENTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

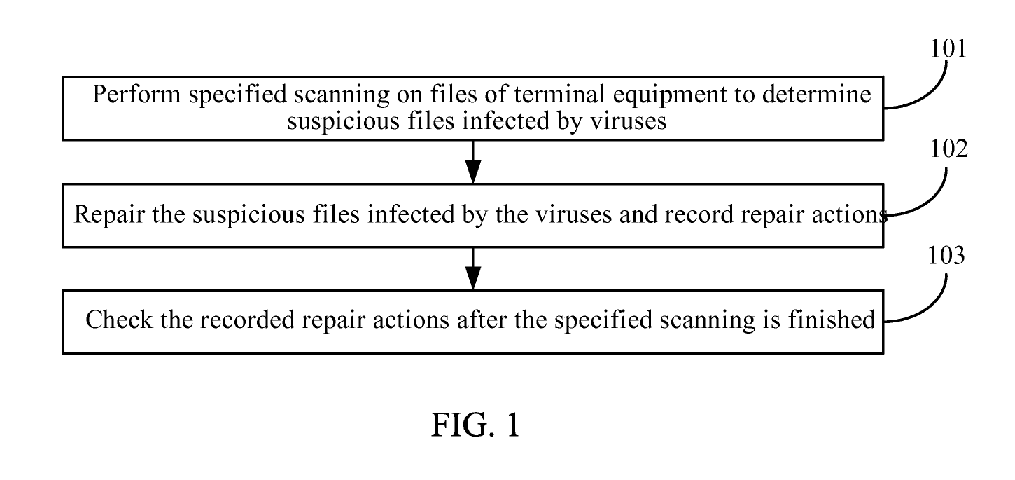

The description will be made as to the embodiments of the present invention in conjunction with the accompanying drawings in FIGS. 1-3. It should be understood that specific embodiments described herein are merely intended to explain the present invention, but not intended to limit the present invention. In accordance with the purposes of this invention, as embodied and broadly described herein, this invention, in one aspect, relates to method and system for filing scanning

Referring to FIG. 1, a flow chart of a method for file scanning is shown according to one embodiment of the present invention. In one embodiment, an entity for executing the method for file scanning includes, but not limited to, terminal equipment. A person skilled in the art should be appreciated that the terminal equipment can be a client terminal device, a server device, or the like. In this exemplary embodiment shown in FIG. 1, the method includes the following steps:

At step 101: specified scanning is performed on files of terminal equipment to determine suspicious files infected by viruses.

The specified scanning in this embodiment refers to quick scanning, full-disc scanning, and scanning on a specified area. Objects of the quick scanning are system files and memory files. Objects of the full-disc scanning are all disc files, including system files and memory files. Objects of the scanning on a specified area are disc files in the specified area.

Specifically, step 101 includes performing the specified scanning on files of the terminal equipment; for each scanned file, determining whether the scanned file matches a virus specimen according to virus specimens in a virus database; and if yes, determining the scanned file to be a suspicious file infected by the virus.

At step 102: the suspicious files infected by the viruses are repaired and repair actions are recorded.

The repair actions in this embodiment refer to eliminating an operating system of the viruses, which include, but not limited to, deleting a file, clearing a virus in a file, restoring a registry, copying a file, or deleting a registry.

Viruses have different features depending on the types thereof Viruses may be parasitic, infectious or hidden. Therefore, repair actions for suspicious files infected by different viruses are different. For example, files infected by parasitic viruses contain the viruses, so the viruses cannot be cleared, and a corresponding repair action is deleting the suspicious files infected by the viruses. Files infected by infectious are merely carriers of the viruses, and a corresponding repair action is clearing the files infected by the viruses, and the files restore a normal state after the viruses carried therein are cleared. Figuratively speaking, a file infected by a virus is like a person getting ill, and to clear the virus is to cure the disease, while to delete the file is as if to kill the person who is ill.

At step 103: the recorded repair actions are checked after the specified scanning is finished.

The check may be checking all repair action sequences of the recorded repair actions one by one, or concurrently checking the suspicious files repaired again after restart and the repair action sequences; the check is not specifically limited in the present invention.

In one embodiment, the step of repairing the suspicious files infected by the viruses and recording the repair actions includes repairing the suspicious files infected by the viruses according to types of the viruses, and recording the repair actions.

In one embodiment, the step of checking the recorded repair actions after the specified scanning is finished includes checking the recorded repair actions by waiting preset time duration after the specified scanning is finished.

In one embodiment, after checking the recorded repair actions, the method further includes ending the procedure if it is found that all the repair actions are successfully executed; prompting a user to restart the terminal equipment if it is found that any one of the repair actions is not successfully executed; and executing the repair action not successfully executed again at an initial stage of a restart procedure of the terminal equipment.

In one embodiment, the step of repairing the suspicious files infected by the viruses and recording the repair actions further include, when the suspicious file infected by the virus is present in a system process, not repairing the suspicious file infected by the virus, and recording the unrepaired suspicious file infected by the virus. Correspondingly, the step of executing the repair action not successfully executed again at the initial stage of the restart procedure of the terminal equipment further includes at the initial stage of the restart procedure of the terminal equipment, repairing the recorded unrepaired suspicious file infected by the virus.

In one embodiment, the initial stage of the restart procedure of the terminal equipment is specifically a stage when the system process is not started during the restart procedure of the terminal equipment.

In one embodiment, after the step of executing the repair action not successfully executed again at the initial stage of the restart procedure of the terminal equipment, the method further includes checking the recorded repair actions again after the terminal equipment is restarted.

In one embodiment, the repair actions are corresponding to the suspicious files infected by the viruses, and include deleting a file, clearing a virus in a file, restoring a registry, copying a file, or deleting a registry.

According to the method for file scanning of the present invention, repair actions performed during the repair procedure are recorded when suspicious files infected by viruses are repaired. These recorded repair actions are checked after the repairs are finished so as to confirm the repair effect and reinforce the repair, thereby preventing suspicious files infected by various viruses from damaging and affecting the system.

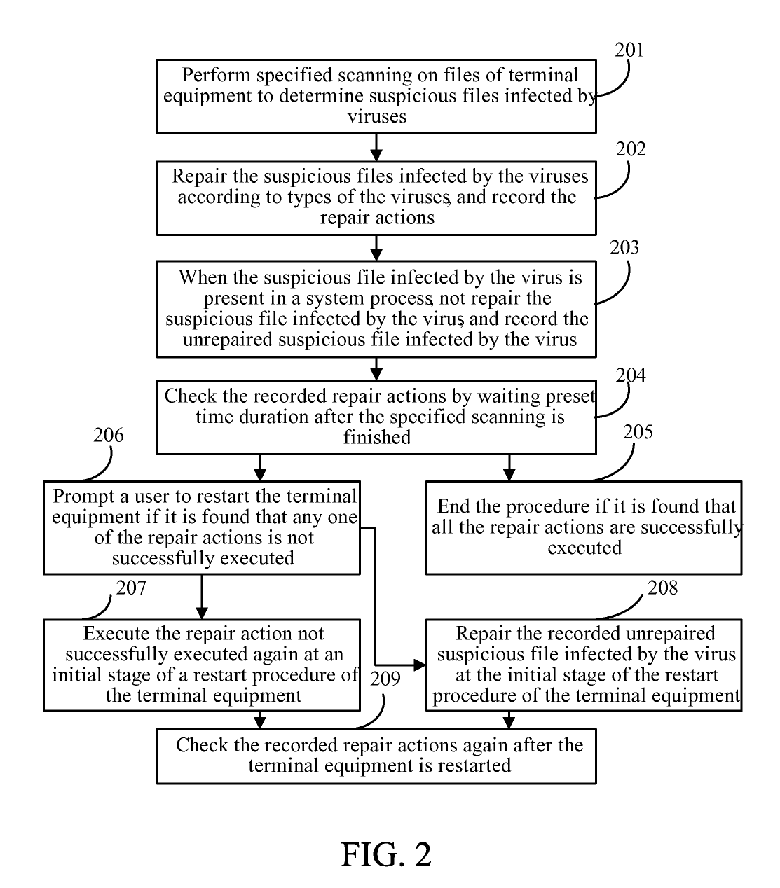

FIG. 2 is a flow chart of a method for file scanning according to another embodiment of the present invention. An entity for executing the method for file scanning includes, but not limited to, terminal equipment. Referring to FIG. 2, the method includes the following steps:

At step 201: specified scanning is performed on files of terminal equipment to determine suspicious files infected by viruses.

A virus database contains multiple virus specimens, and each virus specimen corresponds to one virus type; each virus specimen may contain multiple virus feature codes, and matching is performed between the virus feature codes in each virus specimen and the scanned files. When a scanned file matches up with all the virus feature codes in a virus specimen, the scanned file matches up with the virus specimen, and then it is determined that the scanned file is a suspicious file infected by the virus.

At step 202: the suspicious files infected by the viruses are repaired according to types of the viruses, the repair actions are recorded, and then step 204 is executed.

Specifically, according to the determined suspicious files infected by the viruses among the files of the terminal equipment, and the types of the viruses, the suspicious files infected by the viruses are repaired, and a repair action corresponding to each suspicious file infected by the virus is recorded. In one embodiment, when the repair actions of the suspicious files infected by the viruses are recorded, the repair actions are stored in the form of a queue.

Furthermore, it should be noted that the repair on the suspicious files infected by the viruses may be triggered by a repair instruction; when receiving a repair instruction from the user, the terminal equipment triggers corresponding repairs on the suspicious files infected by the viruses.

At step 203: when the suspicious file infected by the virus is present in a system process, the suspicious file infected by the virus is not repaired, and the unrepaired suspicious file infected by the virus is recorded.

When it is discovered that the suspicious file infected by the virus is present in the system process, the suspicious file infected by the virus is not repaired, and the unrepaired suspicious file infected by the virus is recorded. Repairing the system process when the system is running may cause a system crash, so it is not allowed to repair the suspicious files infected by the viruses present in the system process. To eliminate thoroughly the threaten from the suspicious files infected by the viruses, the unrepaired suspicious file infected by the virus is recorded, so as to be repaired in a subsequent restart procedure.

At step 204: the recorded repair actions are checked by waiting a preset time duration after the specified scanning is finished.

The preset time duration in this embodiment is preset by technicians during development or customized by users.

To eliminate the threaten from the suspicious files infected by the viruses thoroughly, by waiting for preset time duration after the specified scanning is finished, files related to the repair actions are checked one by one according to the repair actions stored in the form of a queue, and some files infected by stubborn viruses are repaired again subsequently according to a checking result, so as to prevent some stubborn viruses from infecting files and registries again and damaging and affecting the system.

In one embodiment, the preset time duration may be of 2 seconds.

Specifically, the step of checking the recorded repair actions may include the following situations: (1) when the recorded repair actions include deleting a file, it is checked whether the deleted file exists, if so, the repair fails, and if not, the repair is successful; (2) when the recorded repair actions includes clearing a virus in a file, it is checked whether the cleared virus is present in the file, if so, the repair fails, and if not, the repair is successful; (3) when the recorded repair actions include restoring a registry value, it is checked whether the registry value is a preset threshold value, if so, the repair fails, and if not, the repair is successful; (4) when the recorded repair actions include deleting a registry, it is checked whether the deleted registry exists, if so, the repair fails, and if not, the repair is successful.

At step 205: the procedure is ended if it is found that all the repair actions are successfully executed.

Repaired objects are checked according to the repair actions. When the repaired objects maintain a repaired state, the repair actions are considered to be successfully executed, and the result is fed back to the user. Specifically, the prompt may be implemented by means of a popup box, for example, if a total of A objects are scanned, B suspicious files are detected, and B files are successfully repaired, the content of the popup box may be “total of objects scanned: A; the number of suspicious files detected: B; the number of files successfully repaired: B”.

At step 206: a user is prompted to restart the terminal equipment, if it is found that any one of the repair actions is not successfully executed.

Repaired objects are checked according to the repair actions. If it is detected that any one or more of repaired objects do not maintain a repaired state, the repair actions are considered to be unsuccessfully executed, and the user is prompted to restart the terminal equipment, so as to make further repairs. Specifically, the prompt may be implemented by means of a popup box, for example, if a total of A objects are scanned, B suspicious files are detected, and C files are successfully repaired, the content of the popup box may be “total of objects scanned: A; the number of suspicious files detected: B, the number of files successfully repaired: C”, and the user is prompted to restart the terminal equipment immediately or later on.

At step 207: the repair action not successfully executed is executed again at an initial stage of a restart procedure of the terminal equipment, and step 209 is executed.

At step 208: the recorded unrepaired suspicious file infected by the virus is repaired at the initial stage of the restart procedure of the terminal equipment.

For example, in the case of a hidden virus that hides itself in the system process, when the system process is in a started state, direct repairs on the system process will lead to a system crash. Therefore, when the system process is in a started state and is not allowed to be repaired, the hidden virus is repaired when the system process is not started during the restart procedure of the terminal equipment.

At step 209: the recorded repair actions are checked again after the terminal equipment is restarted.

After the terminal equipment is restarted and proceeds to the desktop, the repair actions are checked again by using a tray program of the desktop. After the restart, the tray program checks the repaired objects again according to the repair actions, compares the result of the second check with the previously recorded repair actions, and feeds back the repair result during the restart procedure to the user. Specifically, the prompt may be implemented by means of a popup box, for example, if a total of A objects are scanned, B suspicious files are detected, and B files are successfully repaired, the content of the popup box may be “total of objects scanned: A; the number of suspicious files detected: B, the number of files successfully repaired: B”.

Further, after the terminal equipment is restarted, repair conditions of the recorded unrepaired suspicious file infected by the virus are checked.

As disclosed above, the embodiment of the present invention provides a method for file scanning, in which repair actions performed during the repair procedure are recorded when suspicious files infected by viruses are repaired, and these recorded repair actions are checked after the repairs are finished so as to confirm the repair effect and reinforce the repair, thereby preventing suspicious files infected by various viruses from damaging and affecting the system. Moreover, the previously recorded repair actions are checked again after waiting preset time duration, and if unsuccessful repair is detected, the repair is performed again according to the actual condition of the unsuccessful repair, so as to prevent some stubborn viruses from infecting files and registries again and damaging and affecting the system.

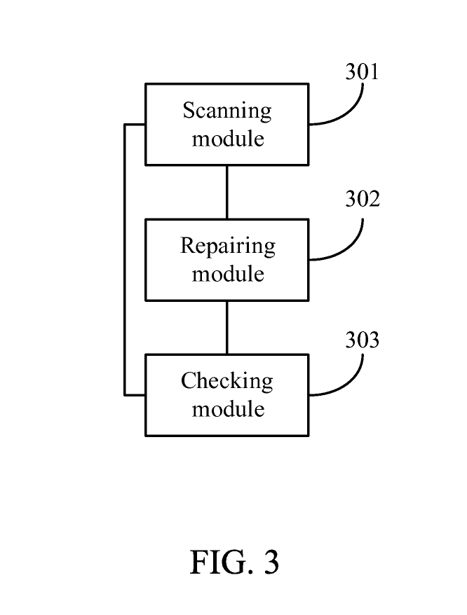

Referring to FIG. 3, a schematic structural diagram of a system for file scanning is shown according to an embodiment of the present invention. As shown in FIG. 3, the system includes a scanning module 301, a repairing module 302, and a checking module 303.

The scanning module 301 is configured to perform specified scanning on files of terminal equipment to determine suspicious files infected by viruses.

The specified scanning in this embodiment refers to quick scanning, full-disc scanning, and scanning on a specified area. Objects of the quick scanning are system files and memory files. Objects of the full-disc scanning are all disc files, including system files and memory files. Objects of the scanning on a specified area are disc files in the specified area.

The repairing module 302 is configured to repair the suspicious files infected by the viruses and recording repair actions.

The repair in this embodiment refers to eliminating an operating system of the viruses, which includes but not limited to, deleting a file, clearing a virus in a file, restoring a registry, copying a file, or deleting a registry.

The checking module 303 is further configured to check the recorded repair actions after the specified scanning is finished.

The check may be checking all repair action sequences of the recorded repair actions one by one, or concurrently checking the suspicious files repaired again after restart and the repair action sequences; the check is not specifically limited in the present invention.

In one embodiment, the repairing module 302 is specifically configured to repair the suspicious files infected by the viruses according to the type of the viruses, and recording the repair actions.

In one embodiment, the repairing module 302 is further configured not to repair the suspicious file infected by the virus when the suspicious file infected by the virus is present in a system process, and to record the unrepaired suspicious file infected by the virus.

In one embodiment, the scanning module 301 is specifically configured to check the recorded repair actions by waiting preset time duration after the specified scanning is finished.

In one embodiment, the checking module 303 is further configured to end the procedure if it is found that all the repair actions are successfully executed.

The checking module 303 is further configured to prompt a user to restart the terminal equipment if it is found that any one of the repair actions is not successfully executed.

The repairing module 302 is further configured to execute the repair action not successfully executed again at an initial stage of a restart procedure of the terminal equipment.

The repairing module 302 is further configured to repair the recorded unrepaired suspicious file infected by the virus at the initial stage of the restart procedure of the terminal equipment.

In one embodiment, the initial stage of the restart procedure of the terminal equipment is specifically a stage when the system process is not started during the restart procedure of the terminal equipment.

In one embodiment, the checking module 303 is further configured to check the recorded repair actions again after the terminal equipment is restarted.

In one embodiment, the repair actions are corresponding to the suspicious files infected by the viruses, and include deleting a file, clearing a virus in a file, restoring a registry, copying a file, or deleting a registry.

According to the system for file scanning disclosed the exemplary embodiment, repair actions performed during the repair procedure are recorded when suspicious files infected by viruses are repaired, and these recorded repair actions are checked after the repairs are finished so as to confirm the repair effect and reinforce the repair, thereby preventing suspicious files infected by various viruses from damaging and infecting the system.

It should be noted that file scanning performed by the system for file scanning provided in the above embodiment is described by taking the division of the functional modules described above as an example. In practical applications, the functions may be allocated to and completed by different functional modules, that is, the internal structure of software is divided into different functional modules to complete all or some functions described above. In addition, the system for file scanning in the above embodiment belongs to the same idea with the embodiment of the method for file scanning, and the for specific implementation process of the system for file scanning, reference may be made to the method embodiment, which is not elaborated herein again.

Another aspect of the present invention provides a non-transitory tangible computer-readable medium storing instructions or codes which, when executed by one or more processors, cause the above system to perform the above method for filing scanning The non-transitory tangible computer-readable storage medium includes, but not limited to, disk, CD-ROM, read-only memory (ROM), random memory (RAM), flash dive, or the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for file scanning, comprising:
performing specified scanning on files of terminal equipment to determine suspicious files infected by viruses;
repairing the suspicious files infected by the viruses and recording repair actions; and
checking the recorded repair actions after the specified scanning is finished.

2. The method according to claim 1, wherein the step of repairing the suspicious files infected by the viruses and recording the repair actions comprises:
repairing the suspicious files infected by the viruses according to types of the viruses, and recording the repair actions.

3. The method according to claim 1, wherein the step of checking the recorded repair actions after the specified scanning is finished comprises:
checking the recorded repair actions by waiting a preset time duration after the specified scanning is finished.

4. The method according to claim 1, after the step of checking the recorded repair actions, further comprising:
ending the procedure if it is found that all the repair actions are successfully executed;
prompting a user to restart the terminal equipment if it is found that any one of the repair actions is not successfully executed; and
executing the repair action not successfully executed again at an initial stage of a restart procedure of the terminal equipment.

5. The method according to claim 4, wherein the step of repairing the suspicious files infected by the viruses and recording the repair actions further comprises:
when the suspicious file infected by the virus is present in a system process, not repairing the suspicious file infected by the virus, and recording the unrepaired suspicious file infected by the virus,
wherein the step of executing the repair action not successfully executed again at the initial stage of the restart procedure of the terminal equipment further comprises:
repairing the recorded unrepaired suspicious file infected by the virus at the initial stage of the restart procedure of the terminal equipment.

6. The method according to claim 4, wherein the initial stage of the restart procedure of the terminal equipment is a stage when the system process is not started during the restart procedure of the terminal equipment.

7. The method according to claim 1, after the step of executing the repair action not successfully executed again at the initial stage of the restart procedure of the terminal equipment, further comprising:
checking the recorded repair actions again after the terminal equipment is restarted.

8. The method according to claim 1, wherein the repair actions are corresponding to the suspicious files infected by the viruses, and comprise deleting a file, clearing a virus in a file, restoring a registry, copying a file, or deleting a registry.

9. A system for file scanning, comprising:
a scanning module, configured to perform specified scanning on files of terminal equipment to determine suspicious files infected by viruses;
a repairing module, configured to repair the suspicious files infected by the viruses and record repair actions; and
a checking module, configured to check the recorded repair actions after the specified scanning is finished.

10. The system according to claim 9, wherein the repairing module is configured to repair the suspicious files infected by the viruses according to types of the viruses, and record the repair actions.

11. The system according to claim 9, wherein the scanning module is configured to check the recorded repair actions by waiting a preset time duration after the specified scanning is finished.

12. The system according to claim 9, wherein the checking module is further configured to end the procedure if it is found that all the repair actions are successfully executed;
the checking module is further configured to prompt a user to restart the terminal equipment if it is found that any one of the repair actions is not successfully executed; and
the repairing module is further configured to execute the repair action not successfully executed again at an initial stage of a restart procedure of the terminal equipment.

13. The system according to claim 9, wherein the repairing module is further configured not to repair the suspicious file infected by the virus when the suspicious file infected by the virus is present in a system process, and to record the unrepaired suspicious file infected by the virus; and
the repairing module is further configured to repair the recorded unrepaired suspicious file infected by the virus at the initial stage of the restart procedure of the terminal equipment.

14. The system according to claim 12, wherein the initial stage of the restart procedure of the terminal equipment is a stage when the system process is not started during the restart procedure of the terminal equipment.

15. The system according to claim 12, wherein the checking module is further configured to check the recorded repair actions again after the terminal equipment is restarted.

16. The system according to claim 9, wherein the repair actions are corresponding to the suspicious files infected by the viruses, and comprise deleting a file, clearing a virus in a file, restoring a registry, copying a file, or deleting a registry.

17. A non-transitory computer-readable medium storing instructions which, when executed by one or more processors, cause a system to perform a method for file scanning, the method comprising:
performing specified scanning on files of terminal equipment to determine suspicious files infected by viruses;
repairing the suspicious files infected by the viruses and recording repair actions; and
checking the recorded repair actions after the specified scanning is finished.
